(19) United States
(12) Patent Application Publication
(10) Pub. No.: US 2016/0303707 A1
(43) Pub. Date: Oct. 20, 2016

(54) MACHINING PROCESS FOR IRON SAND PARTICLE MODIFICATION, IRON SAND PARTICLES AND A GRINDING PANEL OF A CRUSHER

(71) Applicant: Fei Guo, Shenzhen, Guangdong (CN)

(72) Inventor: Junguo Xie, Shenzhen, Guangdong (CN)

(21) Appl. No.: 15/102,527

(22) PCT Filed: Dec. 8, 2014
(86) PCT No.: PCT/CN2014/093300

§ 371 Date: Jun. 7, 2016

(30) Foreign Application Priority Data
Dec. 13, 2013 (CN) 201310687767.1

(51) Int. Cl. B24C 11/00; B02C 23/08; B02C 17/16

(52) U.S. Cl. CPC B24C 11/00; B02C 17/163; B02C 23/08

(57) ABSTRACT

Disclosed is a machining process for iron sand particle modification, iron sand particles and a grinding panel of a crusher, the process comprising the following steps: preliminary screening particle sizes; feeding the preliminarily screened iron sand particles into the cavity of the crusher, so that the iron sand particles pile up in the crusher cavity; the crusher is driven by a motor to conduct secondary grinding and crushing of the iron sand particles; the grinding panel of the crusher stirs the iron sand particles piled up in the crusher cavity to generate and maintain corresponding extruding pressure between the iron sand particles, resulting in self-grinding between the iron sand particles stirred by the grinding panel, thereby changing the specific gravity, shapes, and surface microstructures of the iron sand particles.

### FIELD OF THE INVENTION

The present invention relates to the materials used for sandblasting process, and more particularly to a machining process for iron sand particle modification, iron sand particles used for sandblasting of high-grade aluminum alloy or magnesium alloy and a grinding panel of a crusher.

### BACKGROUND OF THE INVENTION

The existing iron sand particle on the market is provided with loose dendritic structure or spongy structure and it is easy to bring agglomeration phenomenon and it is irregular particle. The iron sand particle will be sheet structure and has blunt surface or flat surface after being crushed in conventional modification process for iron sand particle, and the burrs, dendritic bumps and honeycomb structures on the surface of the iron sand particle cannot be removed effectively by means of the conventional machining process for iron sand particle modification. Thus, such an iron sand particle cannot be used in certain special field, such as sandblasting process for high-grade aluminum alloy or magnesium alloy. Otherwise, it will result in high defect rate, such as unclean surface of iron sand particle, high volatility of gloss, color difference and roughness, irregular cluttered flash point on the surface of processed work piece, which cannot meet the requirements of high-end customers, such as Apple INC.

### SUMMARY OF THE INVENTION

An object of the present invention is to provide a machining process for iron sand particle modification, iron sand particles and a grinding panel of a crusher, so as to overcome the defects of the prior art.

To achieve above objects, there are provided technical solutions as follows:

A machining process for iron sand particle modification, including following steps:

S1: preliminary crushing atomized iron powder which has been reduced once, and preliminary screening particle sizes;

S2: feeding preliminarily screened iron sand particles into an cavity of a crusher by using a feeder, so that the iron sand particles pile up in the cavity of the crusher; secondary grinding and crushing the iron sand particles by the crusher which is driven by a motor; and stirring the iron sand particles piled up in the cavity of the crusher by a grinding panel of the crusher so as to generate and maintain corresponding extruding pressure between the iron sand particles, resulting in self-grinding between the iron sand particles stirred by the grinding panel, and relying on the self-grinding between iron sand particles to change the specific gravity, shapes, and surface microstructures of the iron sand particles; and

S3: feeding the iron sand particles into the cavity of the crusher again by using the feeder after secondary grinding and crushing, and then repeating step S2.

Preferably, the step S2 is repeated not less than three times.

Preferably, the particle size of the iron sand particles selected in step S1 is at a range of particle diameter(D)≧40 μm.

Preferably, preliminary crushing atomized iron powder in step S1 is carried out by using a hammer crusher.

Preferably, the feeder is a self-feeder.

Preferably, the machining process for iron sand particle modification further includes steps of detecting and reading a working current of the motor by a converter controlled by a control unit provided in the self-feeder; increasing a flow of the iron sand particles fed into the crusher when the working current of the motor is less than a predetermined minimum value; and reducing the flow of the iron sand particles fed into the crusher when the working current of the motor is larger than a predetermined maximum value.

Preferably, the predetermined minimum value of working current of the motor is 50 amperes and the predetermined maximum value of working current of the motor is 80 amperes when a rated power of the motor is 30 KW.

Preferably, the crusher has a rotational speed at a range of 1000-1800 r/min.

Preferably, a grinding face of the grinding panel of the crusher has a parabola shaped or arc-shaped outer edge, or is provided with a number of V-shaped grooves in longitudinal direction.

Preferably, the machining process for iron sand particle modification further includes a step of removing dust from the iron sand particles in the step S2 and step S3.

Further provided is an iron sand particle made by the above machining process, wherein all surfaces of the iron sand particle are curved surfaces without flat surface, burrs, dendritic bump and honeycomb structure.

Preferably, the particle diameter of the iron sand particles is at a range of 5 μm-300 μm.

Further provided is a grinding panel of a crusher used in the above machining process, wherein the outer edge of the grinding face of the grinding panel of the crusher is a smooth curved surface.

Preferably, the smooth curved surface is parabola shaped surface or arc-shaped surface.

Further provided is a grinding panel of a crusher used in the above machining process, wherein the grinding face of the grinding panel of the crusher is provided with a number of parallel V-shaped grooves in longitudinal direction.

Preferably, the outer edge of the grinding face of the grinding panel of the crusher is a parabola shaped surface, and the grinding face of the grinding panel of the crusher is provided with a number of parallel V-shaped grooves in longitudinal direction.

Compared with the prior art, the present invention has some beneficial effects as follows:

(1) The process of crushing iron sand particles of the present invention does not use the way in the prior art of beating discrete iron sand particles by using a high-speed crusher (including but not limited to versatile crusher, disc attrition mill, rod mill, Raymond mill), but instead stirs densely packed iron sand particles using the grinding panel of a crusher to generate and maintain corresponding extruding pressure between the iron sand particles, resulting in self-grinding between the iron sand particles stirred by the grinding panel, and relying on the self-grinding between iron sand particles to change the specific gravity, shapes, and surface microstructures of the iron sand particles.

(2) According to the machining process for iron sand particle modification of the present invention, the manufacturing process of the iron sand particles used for sandblasting has been simplified to improve production efficiency and increase output rate of finished product, thereby reducing energy consumption and environmental pollution.

(3) The residual products of powder metallurgy is used as raw material to increase value-added content of the product, thus it can bring huge economic benefits.

(4) According to the machining process of the present invention, the iron sand particle with arc-shaped surface can be produced by repeating the secondary grinding step more than three times, and its apparent density is not less than 3.8/cm³. Compared with the prior art, the machining process of the present invention can improve the productive efficiency of the iron sand particle greatly.

(5) The surface of the iron sand particle is curved surface without flat surface, burrs, dendritic bump and honeycomb structure, thereby ensuring the quality of sandblasted surface of the work piece.

(6) The sharp corner formed on an outer edge of the grinding panel of the conventional crusher is grinded to be smooth curved surface so as to reducing the cutting force applied to the iron sand particle by the grinding panel of the crusher, thereby reducing the chance of producing blunt surface or flat surface on the iron sand particle.

(7) The dust removing step can extract the tiny dust from the iron sand particles thereby reducing the fine powder pollution for the iron sand particle. The extracted tiny dust is super fine iron powder containing more than 98% of iron, which can be sold, thereby further increasing economic efficiency.

### BRIEF DESCRIPTION OF THE DRAWINGS

FIG. 1 is a functional block diagram illustrating the present invention;

FIG. 2 is a structure diagram showing the surface of the iron sand particle of the prior art;

FIG. 3 is a structure diagram showing the surface of the iron sand particle of the present invention;

FIG. 4 is a front view showing the grinding face of the grinding panel of the crusher of the prior art;

FIG. 5 is a side view showing the grinding face of the grinding panel of the crusher of the prior art;

FIG. 6 is a side view showing the grinding face of the grinding panel of the crusher of the present invention according to a first embodiment;

FIG. 7 is a side view showing the grinding face of the grinding panel of the crusher of the present invention according to a second embodiment;

FIG. 8 is a front view showing the grinding face of the grinding panel of the crusher of the present invention according to a third embodiment;

FIG. 9 is A-A section view of FIG. 8;

FIG. 10 is a side view showing the grinding face of the grinding panel of the crusher of the present invention according to a fourth embodiment; and

FIG. 11 is B-B section view of FIG. 8.

### DETAILED DESCRIPTION OF ILLUSTRATED EMBODIMENTS

Some embodiments of the present invention will be described as follows, by way of example only, with reference to the accompanying drawings.

As shown in FIG. 1, which is a functional block diagram illustrating the present invention, a machining process for iron sand particle modification includes the following steps:

S1: preliminary crushing atomized iron powder which has been reduced once, and preliminary screening particle sizes, the particle size of the selected iron sand particles being at a range of particle diameter(D)≧40 μm.

S2: feeding preliminarily screened iron sand particles into an cavity of a crusher by using a feeder, so that the iron sand particles pile up in the cavity of the crusher; the crusher is driven by a motor to conduct secondary grinding and crushing of the iron sand particles; a grinding panel of the crusher stirs the iron sand particles piled up in the cavity of the crusher to generate and maintain corresponding extruding pressure between the iron sand particles, resulting in self-grinding between the iron sand particles stirred by the grinding panel, and relying on the self-grinding between iron sand particles to change the specific gravity, shapes, and surface microstructures of the iron sand particles;

S3: feeding the iron sand particles after secondary grinding and crushing into the cavity of the crusher again by using the feeder, and then repeating step S2.

In this embodiment, the step S2 is repeated not less than three times.

In this embodiment, the atomized iron powder in step S1 is slightly and preliminarily crushed by using a hammer crusher.

In this embodiment, the feeder is a self-feeder 10.

In this embodiment, it further includes steps of detecting and reading a working current of the motor 30 by a converter 20 controlled by a control unit provided in the self-feeder 10; increasing a flow of the iron sand particles fed into the crusher when the working current of the motor 30 is less than a predetermined minimum value; and reducing the flow of the iron sand particles fed into the crusher when the working current of the motor 30 is larger than a predetermined maximum value.

In this embodiment, the predetermined minimum value of working current of the motor is 50 amperes and the predetermined maximum value of working current of the motor is 80 amperes when a rated power of the motor is 30 KW.

In this embodiment, the crusher has a rotational speed at a range of 1000-1800 r/min.

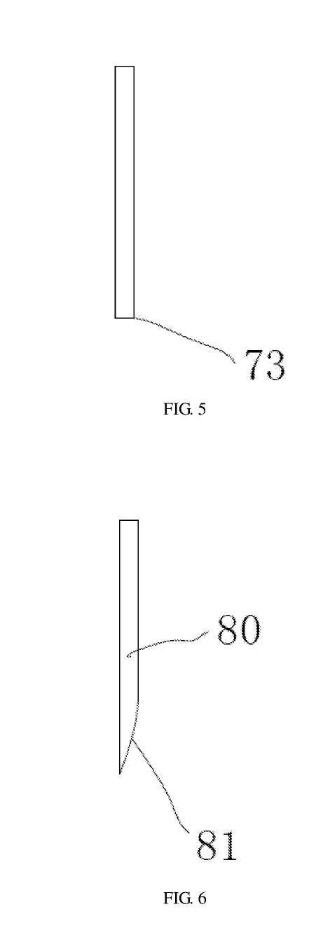

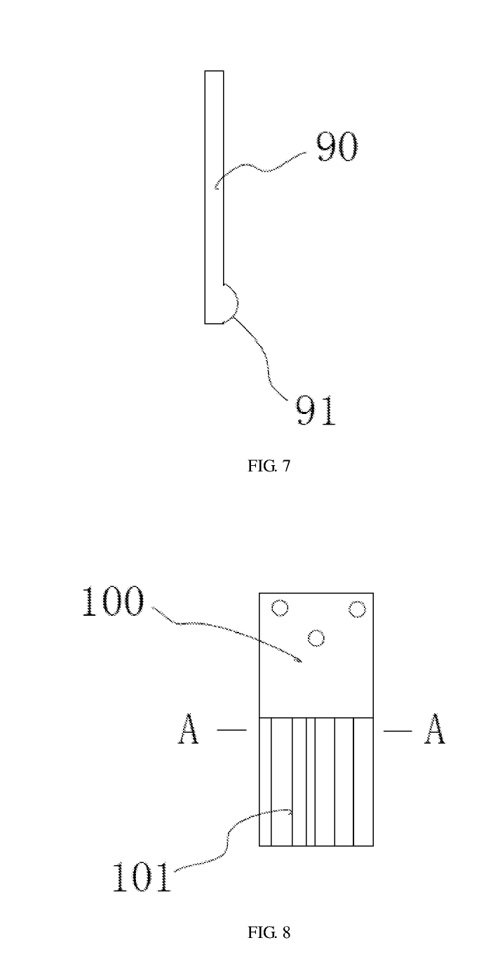

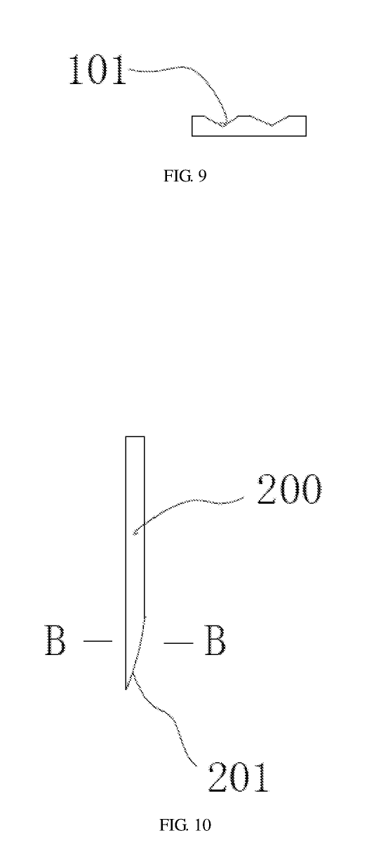

In this embodiment, a grinding face of the grinding panel of the crusher has parabola shaped or arc-shaped outer edge, or is provided with a number of V-shaped grooves in longitudinal direction (as shown in FIG. 6, FIG. 7, FIG. 8 and FIG. 9).

In this embodiment, it further includes a step of removing dust from the iron sand particles in the step S2 and step S3.

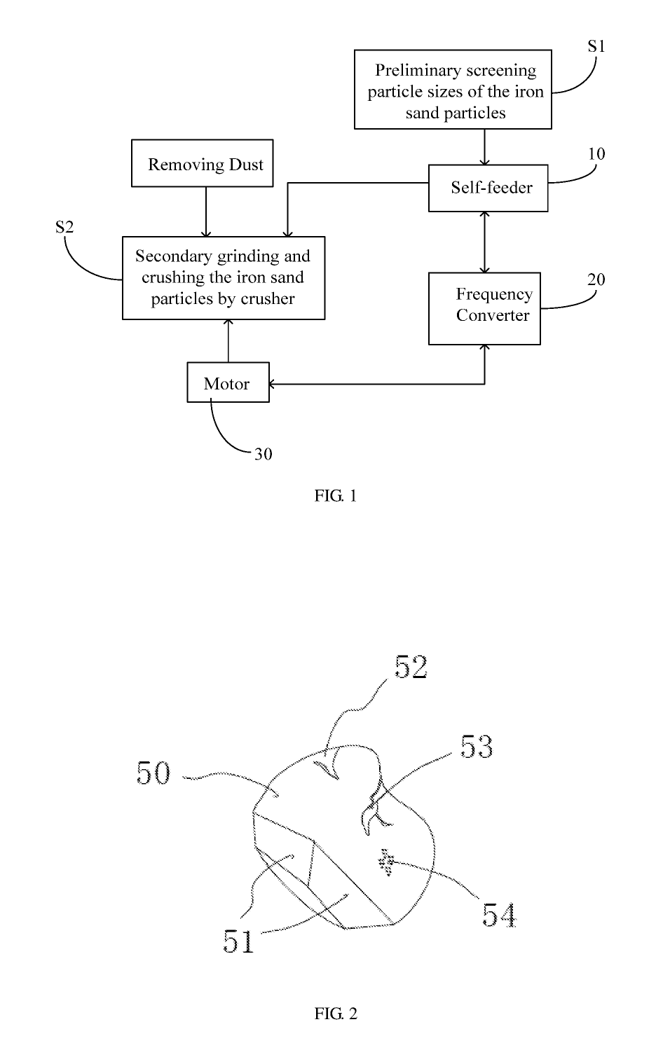

As shown in FIG. 2, it is a structure diagram showing the surface of the iron sand particle of the prior art. And as shown in the following Picture 1, it is a photograph of the iron sand particle of the prior art.

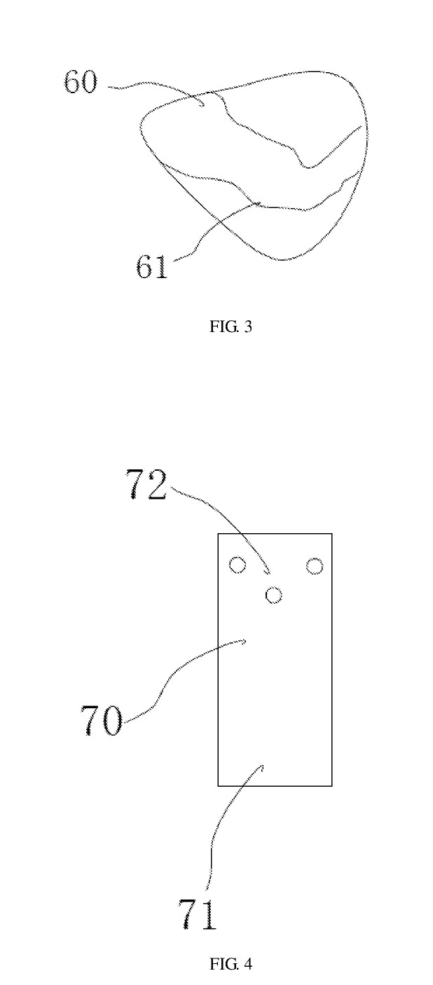

As shown in FIG. 3, it is a structure diagram showing the surface of the iron sand particle of the present invention. And as shown in the following Picture 2, it is a photograph of the iron sand particle of the present invention.

The iron sand particle 50 of the prior art includes flat surface 51, and the surface of the iron sand particle 50 can be observed to has burrs 52, dendritic bump 53 or honeycomb structure 54 under a microscope. The surface of the iron sand particle 60 of the present invention is curved surface 61 without burrs 52, dendritic bump 53 and honeycomb structure 54, all of which appear on the surface of the iron sand particle 50 of the prior art.

In this embodiment, the particle diameter of the iron sand particles 60 is at a range of 5 μm-300 μm.

As shown in FIG. 4, it is a front view showing the grinding face of the grinding panel of the crusher of the prior art; and as shown in FIG. 5, it is a side view showing the grinding face of the grinding panel of the crusher of the prior art. In the prior art, the inner edge 72 of the grinding panel 70 is used to connect with the main spindle of the crusher, the front side of the outer edge 71 is used for hitting the iron sand particles, and the front side of the outer edge 71 has an edge 73.

Further provided is a grinding panel of a crusher, the outer edge of which is a smooth curved surface.

In an embodiment, the smooth curved surface formed on the grinding panel 80 is parabola shaped surface 81, as shown in FIG. 6.

In another embodiment, the smooth curved surface formed on the grinding panel 90 is parabola shaped surface 91, as shown in FIG. 7.

Further provided is a grinding panel of a crusher, the grinding face 100 of which is provided with a number of parallel V-shaped grooves 101 in longitudinal direction, as shown in FIG. 8 and FIG. 9.

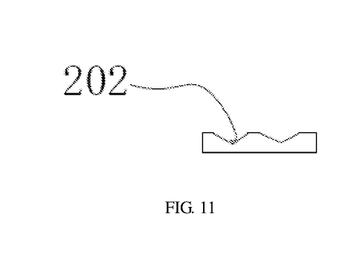

Further provided is a grinding panel of a crusher, the outer edge of which is a parabola shaped surface 201 and the grinding face 200 of which is provided with a number of parallel V-shaped grooves 202 in longitudinal direction, as shown in FIG. 10 and FIG. 11.

Above descriptions of embodiments are provided for further illustrating the technical content of the present invention, so as to facilitate understanding and it should be understood that the invention is not to be limited to the disclosed embodiments. Any technique extension and recreation according to the present invention should be included within the scope of protection of the invention.

1. A machining process for iron sand particle modification, comprising following steps:
S1: preliminary crushing atomized iron powder which has been reduced once, and preliminary screening particle sizes;
S2: feeding preliminarily screened iron sand particles into an cavity of a crusher by using a feeder, so that the iron sand particles pile up in the cavity of the crusher; secondary grinding and crushing the iron sand particles by the crusher which is driven by a motor; and
stirring the iron sand particles piled up in the cavity of the crusher by a grinding panel of the crusher so as to generate and maintain corresponding extruding pressure between the iron sand particles, resulting in self-grinding between the iron sand particles stirred by the grinding panel, and relying on the self-grinding between iron sand particles to change the specific gravity, shapes, and surface microstructures of the iron sand particles; and
S3: feeding the iron sand particles into the cavity of the crusher again by using the feeder after secondary grinding and crushing, and then repeating step S2.

2. The machining process for iron sand particle modification according to claim 1, wherein the step S2 is repeated not less than three times.

3. The machining process for iron sand particle modification according to claim 1, wherein the particle size of the iron sand particles selected in step S1 is at a range of particle diameter(D) 40 μm.

4. The machining process for iron sand particle modification according to claim 1, wherein preliminary crushing atomized iron powder in step S1 is carried out by using a hammer crusher.

5. The machining process for iron sand particle modification according to claim 1, wherein the feeder is a self-feeder.

6. The machining process for iron sand particle modification according to claim 5, wherein further comprises steps of detecting and reading a working current of the motor by a converter controlled by a control unit provided in the self-feeder; increasing a flow of the iron sand particles fed into the crusher when the working current of the motor is less than a predetermined minimum value; and reducing the flow of the iron sand particles fed into the crusher when the working current of the motor is larger than a predetermined maximum value.

7. The machining process for iron sand particle modification according to claim 6, wherein the predetermined minimum value of working current of the motor is 50 amperes and the predetermined maximum value of working current of the motor is 80 amperes when a rated power of the motor is 30 KW.

8. The machining process for iron sand particle modification according to claim 1, wherein the crusher has a rotational speed at a range of 1000-1800 r/min.

9. The machining process for iron sand particle modification according to claim 1, wherein a grinding face of the grinding panel of the crusher has a parabola shaped or arc-shaped outer edge, or is provided with a number of V-shaped grooves in longitudinal direction.

10. The machining process for iron sand particle modification according to claim 9, wherein further comprises a step of removing dust from the iron sand particles in the step S2 and step S3.

11. An iron sand particle made by the machining process according to claim 1, wherein all surfaces of the iron sand particle are curved surfaces without flat surface, burrs, dendritic bump and honeycomb structure.

12. The iron sand particle according to claim 11, wherein the particle diameter of the iron sand particles is at a range of 5 μm-300 μm.

13. A grinding panel of a crusher used in the machining process according to claim 1, wherein the outer edge of the grinding face of the grinding panel of the crusher is a smooth curved surface.

14. The grinding panel of the crusher according to claim 13, wherein the smooth curved surface is parabola shaped surface or arc-shaped surface.

15. A grinding panel of a crusher used in the machining process according to claim 1, wherein the grinding face of the grinding panel of the crusher is provided with a number of parallel V-shaped grooves in longitudinal direction.

16. A grinding panel of a crusher used in the machining process according to claim 1, wherein the outer edge of the grinding face of the grinding panel of the crusher is a parabola shaped surface, and the grinding face of the grinding panel of the crusher is provided with a number of parallel V-shaped grooves in longitudinal direction.
